(19) United States
(12) Patent Application Publication
(10) Pub. No.: US 2018/0177118 A1
(43) Pub. Date: Jun. 28, 2018

(54) SEEDLING TRANSPLANTER

(71) Applicant: Dong Ken KIM, Gangwon-do (KR)

(72) Inventor: Dong Ken KIM, Gangwon-do (KR)

(21) Appl. No.: 15/556,445

(22) PCT Filed: Mar. 17, 2016
(86) PCT No.: PCT/KR2016/002684

§ 371 Date: Feb. 20, 2018

(30) Foreign Application Priority Data
Mar. 18, 2015 (KR) 10-2015-0037631

(51) Int. Cl. A01C 5/02

(52) U.S. Cl. CPC A01C 5/02

(57) ABSTRACT

The present invention relates to a seedling transplanter, and the purpose of the present invention is to provide a seedling transplanter which enables a user to hold the seedling transplanter with one hand and put a seedling into the seedling transplanter with the other hand to plant the seedling, thereby allowing fast work to be achieved without an additional worker and minimizing soil pushed away from side portions of the seedling by the seedling transplanter during planting, such that the seedling can be planted appropriately. To achieve the aforementioned object, a seedling transplanter of the present invention includes: first and second rods which have a bar shape and handles at upper sides thereof, and are hingedly coupled to each other; a first side plate which is positioned at a lower side of the first rod, has a closed rear side, and is inclined inward downward; and a second side plate which is positioned at a lower side of the second rod, has a closed rear side, and is inclined inward downward, such that the rear side and a lower end of the second side plate face a lower end of the first side plate, in which front sides of the first and second side plates are opened.

### TECHNICAL FIELD

The present invention relates to a seedling transplanter capable of allowing a user to plant a seedling of a plant, and more particularly, to a seedling transplanter capable of allowing a user to conveniently plant, with one hand, a seedling of a plant in a cultivation field and allowing the seedling to be planted upright so that the seedling can be planted appropriately.

### BACKGROUND ART

Typically, to cultivate various types of plants, a user sows seeds in a pot or the like, grows seedlings to a certain size, and then moves and plants the seedlings in a cultivation field. A large amount of plants can be planted by using mechanical power in a big-scale farm, but a machine using the mechanical power is highly priced, and as a result, plants are planted by using a hoe or a shovel mostly in a small-scale farm.

However, the planting work using the hoe or the shovel causes great fatigue of a worker. Korean Utility Model Registration No. 20-0275296 discloses, as illustrated in FIG. 1, shovel blades 1 and 1′ which are provided to face each other and each have a hemispheric end that is pointy so as to be easily dug into the soil 6, and an upper end that has a hemispheric shape and bolt insertion openings 4 formed at both sides thereof, such that bolts 5 are fastened to the bolt insertion openings 4, respectively, so as to serve as hinges.

Further, shafts 3, which are attached to rear portions of upper ends of the shovel blades 1 and 1′ by welding or fastening means, are configured to be long or short in accordance with work and uses, and handles 2 and 2′ are provided at ends of the shafts 3.

Therefore, as illustrated in FIGS. 2, 3, and 4, the shovel blades 1 and 1′ are inserted into the soil 6 in a state in which the handles 2 and 2′ are moved away from each other in a furrow in the soil 6 formed in fields or paddies, a seedling 7 is putted into a space between the shovel blades 1 and 1′, and then the handles 2 and 2′ are moved toward each other, such that shovel blades 1 and 1′ are spread about the bolts 5.

Further, when the seedling transplanter inserted into the soil 6 is raised, the seedling 7 accommodated in the shovel blades 1 and 1′ is buried in the soil and the seedling transplanter is moved out of the soil.

However, in the case of the seedling transplanter in the related art, the worker needs to use two hands to spread the handles 2 and 2′ and to put the handles 2 and 2′ together. Therefore, to insert the seedling 7 between the shovel blades 1 and 1′, the worker needs to take his/her hands off the handles 2 and 2′ or an additional worker is required, and as a result, there is a problem in that the work is very inconvenient and a long period of time is required, which cause deterioration in working efficiency.

In addition, in a case in which the seedling transplanter is raised after planting the seedling by spreading the shovel blades 1 and 1′, the soil at both sides of the shovel blades 1 and 1′ is pushed outward by the shovel blades 1 and 1′ and does not move toward the seedling 7, such that the seedling 7 cannot be planted upright, but the seedling 7 is inclined, and as a result, there is a problem in that the seedling 7 cannot be planted appropriately.

Further, the seedling 7 with a vinyl film having a hole is widely used for convenience. In this case, in a case in which a leaf is larger than the existing hole, the hole needs to be widely spread when the shovel blades 1 and 1′ are withdrawn, and as a result, the vinyl film is torn.

Furthermore, to plant a plant, such as a chilli seedling, having a large size, the shovel blades 1 and 1′ need to be withdrawn to a height higher than the size of the plant, and as a result, there is a problem in that a great effort and a long period of time are required.

### DISCLOSURE

### Technical Problem

The present invention has been made in an effort to solve the problems in the related art, and an object of the present invention is to provide a seedling transplanter which enables a user to hold the seedling transplanter with one hand and put a seedling into the seedling transplanter with the other hand in order to plant the seedling, thereby allowing fast work to be achieved without an additional worker, and minimizing soil pushed away from side portions of the seedling by the seedling transplanter during planting, such that the seedling can be planted appropriately, and because the seedling transplanter can be withdrawn in an inclined state, it is not necessary to spread the seedling transplanter to the size of a leaf of the seedling and it is not necessary to raise the seedling transplanter high.

### Technical Solution

To achieve the aforementioned object, a seedling transplanter of the present invention includes: first and second rods which have a bar shape and handles at upper sides thereof, and are hingedly coupled to each other; a first side plate which is positioned at a lower side of the first rod, has a closed rear side, and is inclined inward downward, and a second side plate which is positioned at a lower side of the second rod, has a closed rear side, and is inclined inward downward, such that the rear side and a lower end of the second side plate face and abut against a lower end of the first side plate, in which front sides of the first and second side plates are opened.

### Advantageous Effects

According to the present invention, a user holds handles with one hand, positions a seedling between a fixing plate and an opening and closing unit with the other hand, puts the soil into the seedling transplanter, and then operates an operating handle, such that the opening and closing unit is moved laterally and the seedling is naturally planted, and as a result, the present invention has an excellent working efficiency in that the planting work is conveniently performed by a single person.

In addition, in a case in which the seedling is high or a leaf is wide, the seedling transplanter of the present invention is inclined rearward and then withdrawn in a state in which the seedling is planted, such that the seedling may be naturally withdrawn and planted through opened sides of the first side plate and the second side plate. Further, since the seedling is planted after being inserted into the seedling transplanter, an unnecessary space is reduced, and the user holds the seedling transplanter narrowly, and as a result, the user can plant the seedling with less effort, and the soil is in close contact with the opened side at the front side, such that the seedling is held when the seedling is withdrawn. For this reason, the seedling can be appropriately planted upright. Furthermore, since the seedling transplanter is opened laterally only in an area including the seedling, a minimum amount of soil is moved, and as a result, the user spreads the seedling transplanter with less effort.

### DESCRIPTION OF DRAWINGS

FIGS. 1 to 4 are views for explaining a transplanter in the related art.

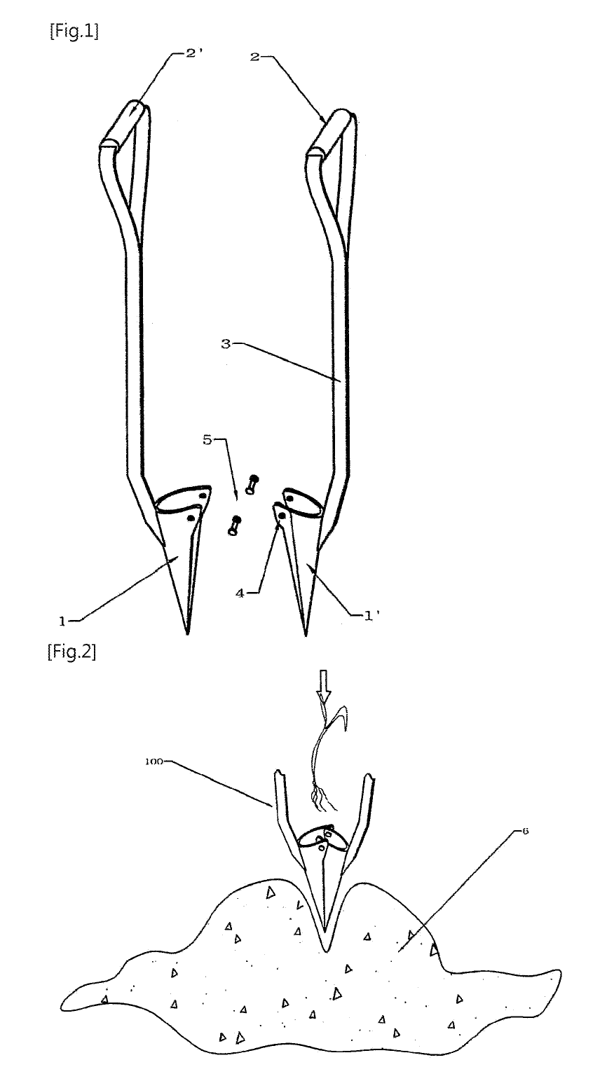

FIG. 5 is a view illustrating a structure of a seedling transplanter according to a first exemplary embodiment of the present invention.

FIG. 6 is a side view of a side plate.

FIG. 7 is a view for explaining an operation of the present invention.

FIG. 8 is a view illustrating a second exemplary embodiment of the present invention.

### DESCRIPTION OF MAIN REFERENCE NUMERALS OF DRAWINGS

110, 120: rod
111, 121: handle
112, 122: side plate
113, 123: rear blocking plate
114, 124: hinge
140: spring
150: front opening

### MODES OF THE INVENTION

A seedling transplanter of the present invention will be described in detail with reference to the accompanying drawings.

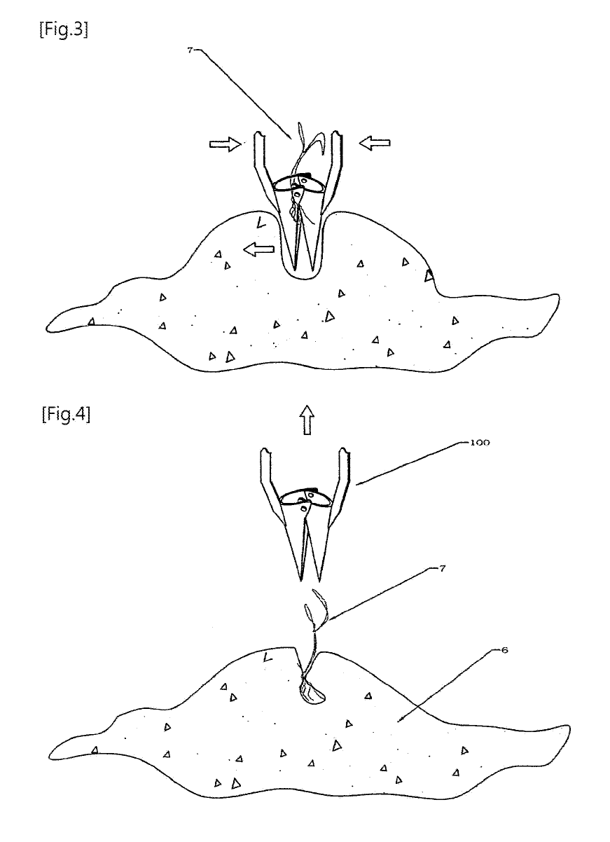

FIG. 5 is a view illustrating a structure of a seedling transplanter 100 according to a first exemplary embodiment of the present invention. A first handle 111 is provided in a front and rear direction at a front side of a bar-shaped first rod 110, and a first side plate 112 is provided at a lower side of the first rod 110.

The first rod 110 may be formed in the form of a plate, and the first side plate 112 is positioned in the front and rear direction at the lower side of the first rod 110. In this case, a closed first rear blocking plate 113 is provided at a rear side of the first side plate 112, and the closed side may be closed by the lower side of the first rod 110.

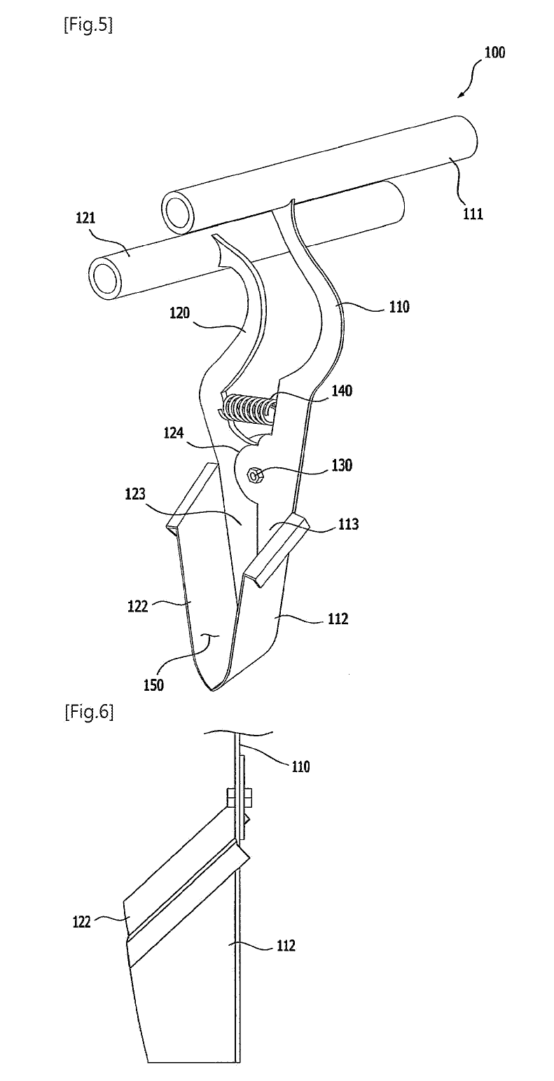

As illustrated in a side view in FIG. 6, the first side plate 112 has a plate shape, and the first side plate 112 is inclined inward downward.

In addition, a first hinge 114, which extends laterally from the first rod 110, is formed at an upper side of the first side plate 112.

A second rod 120 is also formed in a bar shape, a second handle is formed in the front and rear direction at an upper side of the second rod 120, and a second side plate 122 is provided at a lower side of the second rod 120. The second side plate 122 is formed in the form of a plate, and the second side plate 122 is inclined inward downward.

Further, a closed second rear blocking plate 123 is provided at a rear side of the second side plate 122, and a second hinge 124 is formed on the second rod 120 at a position corresponding to the first hinge 114 at an upper side of the second side plate 122.

Therefore, the first hinge 114 and the second hinge 124 are coupled to each other by a hinge pin 130, and a spring 140 is installed between the first rod 110 and the second rod 120 at an upper side of the hingedly coupled portion, thereby elastically supporting the first rod 110 and the second rod 120.

The first and second side plates 112 and 122 are retracted inward and come into contact with each other by the spring 140, a lower end of the first side plate 112 and a lower end of the second side plate 122 come into contact with each other, opposing side portions of the first and second rear blocking plates 113 and 123 come into contact with each other and close lower ends and rear sides of the first and second side plates 112 and 122, such that a space for accommodating the seedling is formed.

Furthermore, an opened front opening 150 is formed at front sides of the first and second side plates 112 and 122.

Further, the second handle 121 is positioned at a position lower than the first handle 111, such that a thumb and a palm of the worker are positioned on the first handle 111, and the remaining fingers of the worker are positioned on the second handle 121, thereby reducing fatigue of the hand.

An operation of the present invention will be described.

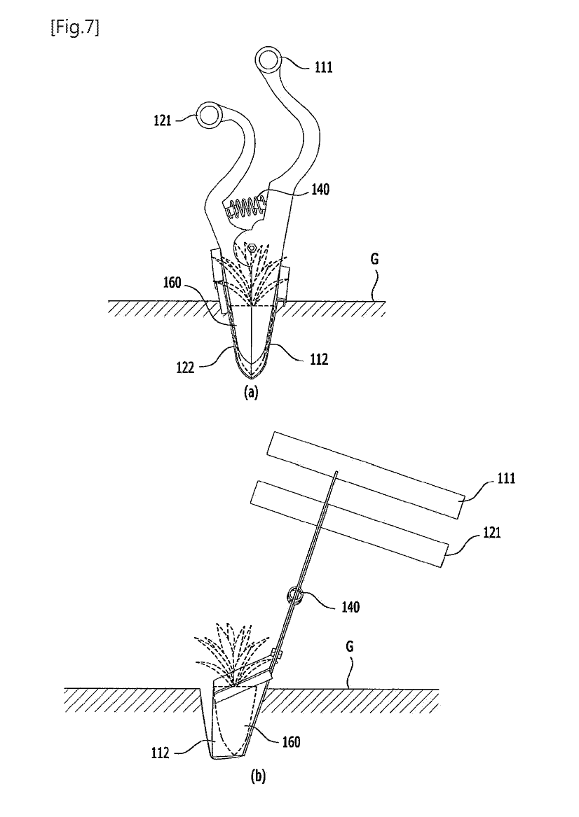

A seedling 160 to be planted is seated in the space between the first side plate 112 and the second side plate 122 in a state in which the seedling transplanter of the present invention is positioned upright as illustrated in FIG. 7A, and then the seedling transplanter is pushed or dug into the soil in the cultivation field in a vertical direction so that the seedling 160 is buried while a hole is formed in the ground G by the first and second side plates 121 and 122.

Thereafter, when the worker grasps the first handle 111 and the second handle 121, the first side plate 112 and the second side plate 122 are moved away from each other and separated from the seedling 160. As illustrated in FIG. 7B, when the first rod 110 and the second rod 120 are inclined rearward, the seedling 160 is naturally withdrawn while the first side plate 112 and the second side plate 122 are inclined rearward in a state in which the seedling 160 is fixed in position through the front opening 150.

In this inclined state, when the seedling transplanter of the present invention is raised to be inclined upward, the seedling 160 is positioned upright in position while the soil is parted minimally.

That is, the seedling transplanter of the present invention is inclined rearward to withdraw the seedling 160, and the seedling transplanter of the present invention is withdrawn from the ground G, in a state in which the first side plate 112 and the second side plate 122 are spread minimally, such that the soil can naturally cover the seedling 160, and the seedling having a leaf smaller than a root may be withdrawn without being inclined.

When the second handle 121 is released after the seedling 160 is completely planted, the first and second side plates 112 and 122 are retracted inward again by restoring force of the spring 140.

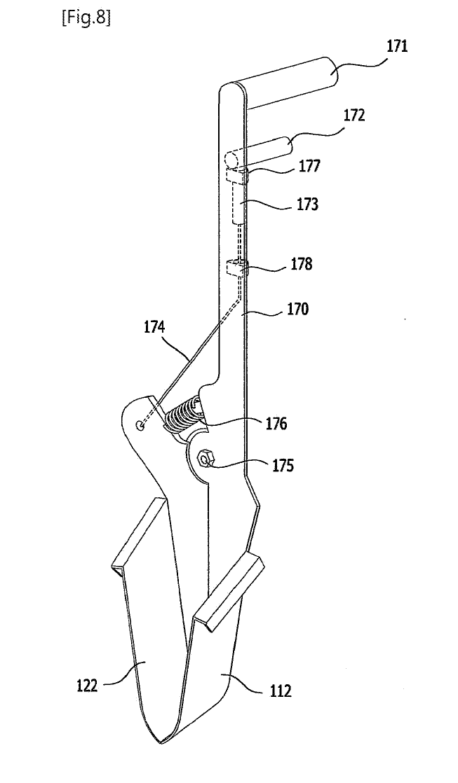

FIG. 8 is a front view illustrating a second exemplary embodiment of the present invention, and structures of the first and second side plates 112 and 122 are the same as those in the first exemplary embodiment.

A rod 170 is positioned upright at the upper side of the first side plate 112, and a fixed handle 171 is provided at an upper end of the rod 170.

A movable handle 172, which is moved in an up and down direction, is provided at a lower side of the fixed handle 171, the movable handle 172 is bent in the form of “, and a connecting bar 173 in the vertical direction is fixed at a lateral side of the rod 170 by a ring-shaped fixing unit 177 fixed to the rod 170 so that the connecting bar 173 is movable in the up and down direction.

A hinge 175 provided on the first side plate 112 is positioned in the vicinity of a central axis of the rod 170 and hingedly coupled to the second side plate 122, one end of a wire 174 is fixed to an outer portion at an upper side of the second side plate 122, the wire 174 penetrates a ring-shaped fixing unit 178 positioned at a lateral side of the rod 170, and the other end of the wire 174 is fixed to a lower end of the connecting bar 173.

Furthermore, a spring 176 is installed between the first side plate 112 and the second side plate 122 at an upper side of the hinge 175.

Therefore, when the worker pulls the movable handle 172, the wire 174 is pulled, and the first side plate 112 and the second side plate 122 are spread while the second side plate 122 is rotated outward about the hinge 175 from the first side plate 112.

Because an operating state of the second exemplary embodiment is the same as the operating state of the first exemplar) embodiment, a detailed description thereof will be omitted.

1. A seedling transplanter comprising:
first and second rods which have a bar shape and handles at upper sides thereof, and are hingedly coupled to each other;
a first side plate which is positioned at a lower side of the first rod, has a closed rear side, and is inclined inward downward; and
a second side plate which is positioned at a lower side of the second rod, has a closed rear side, and is inclined inward downward, such that the rear side and a lower end of the second side plate face the rear side and a lower end of the first side plate,
wherein front sides of the first and second side plates are opened.

2. The seedling transplanter of claim 1, wherein a spring is provided between the first rod and the second rod.

3. The seedling transplanter of claim 1, wherein the first rod and the second rod have different heights.

4. A seedling transplanter comprising:
a rod which has a bar shape, and a fixed handle and a movable handle provided at an upper side of the rod;
a first side plate which is positioned at a lower side of the rod, has a closed rear side, and is inclined inward downward;
a second side plate which is hingedly coupled to the first side plate, has a closed rear side, and is inclined inward downward, such that the rear side and a lower end of the second side plate abut against a lower end of the first side plate; and
a wire which connects the second side plate and the movable handle, and rotates the second side plate outward when the movable handle is operated,
wherein front sides of the first and second side plates are opened.

5. The seedling transplanter of claim 1, wherein a spring is provided between the first side plate and the second side plate.
